(19) United States
(12) Patent Application Publication
(10) Pub. No.: US 2017/0026906 A1
(43) Pub. Date: Jan. 26, 2017

(54) METHODS, SYSTEMS, AND APPARATUS FOR SAVING POWER BY SYNCHRONIZING WAKEUP INTERVALS

(71) Applicant: QUALCOMM Incorporated, San Diego, CA (US)

(72) Inventors: Bhasker NETI, Hyderabad (IN); Rohit SINGH, Hyderabad (IN); Ajay Kumar GAJA, Hyderabad (IN)

(21) Appl. No.: 14/809,259

(22) Filed: Jul. 26, 2015

(51) Int. Cl. H04W 52/02; H04W 76/02; H04W 4/00

(52) U.S. Cl. CPC H04W 52/0216; H04W 4/008; H04W 76/025; H04W 76/026; H04W 84/12

(57) ABSTRACT

Techniques for synchronizing wakeup intervals are disclosed. In one example, a first access terminal that has both Bluetooth and Wi-Fi capabilities may include a communication controller that when the first access terminal detects that WLAN connectivity is turned ON, the communication controller adjusts the sniff anchor point for Bluetooth connectivity such that the sniff anchor points are aligned with the WLAN beacon intervals. In another example, the first access terminal has the WLAN connectivity turned ON and connected to an access point before a Bluetooth connection to a second access terminal is established. The communication controller may set the Bluetooth sniff interval and sniff anchor points such that they are in multiple of the beacon interval.

### FIELD OF DISCLOSURE

Aspects of this disclosure relate generally to telecommunications, and more particularly to co-existence between wireless Radio Access Technologies (RATs) and the like.

### BACKGROUND

Wireless communication systems are widely deployed to provide various types of communication content, such as voice, data, multimedia, and so on. Typical wireless communication systems are multiple-access systems capable of supporting communication with multiple users by sharing available system resources (e.g., bandwidth, transmit power, etc.). Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and others. Another example is Bluetooth. Bluetooth is a standard for wireless communications between devices in a personal area network (PAN) using radio frequency in the 2.4 GHz band for short range (around 10 meters) connectivity. These systems are often deployed in conformity with specifications such as Long Term Evolution (LTE) provided by the Third Generation Partnership Project (3GPP), Ultra Mobile Broadband (UMB) and Evolution Data Optimized (EV-DO) provided by the Third Generation Partnership Project 2 (3GPP2), 802.11 provided by the Institute of Electrical and Electronics Engineers (IEEE), and Bluetooth standards (such as IEEE 802.15.1), etc.

In Wi-Fi networks, like Bluetooth networks, access points provide connectivity and coverage to a large number of users over a certain geographical area. Access point deployment is carefully planned, designed, and implemented to offer good coverage over the geographical region.

Recently, small cell LTE operations, for example, have been extended into the unlicensed frequency spectrum such as the Unlicensed National Information Infrastructure (U-NII) band used by Wireless Local Area Network (WLAN) technologies. This extension of small cell LTE operations is designed to increase spectral efficiency and hence capacity of the LTE system. However, it may also encroach on the operations of other Radio Access Technologies (RATs) that typically utilize the same unlicensed bands, most notably IEEE 802.11x WLAN technologies generally referred to as “Wi-Fi.” Such conflicts are further complicated by the ability of mobile devices to use different RATs at the same time. For example, a mobile device may have initiated a Wi-Fi connection while simultaneously trying to initiate a Bluetooth connection to an access point.

Bluetooth and Wi-Fi (the brand name for products using IEEE 802.11 standards) have some similar applications: setting up networks, printing, or transferring files. Wi-Fi is intended as a replacement for high speed cabling for general local area network access in work areas. This category of applications is known as wireless local area networks (WLAN). Bluetooth was intended for portable equipment and its applications. This category of applications is known as wireless personal area network (WPAN). Bluetooth is a replacement for cabling in a variety of personally carried applications in any setting, and also works for fixed location applications such as smart energy functionality in the home (thermostats, etc.).

Wi-Fi and Bluetooth are to some extent complementary in their applications and usage. Wi-Fi is usually access point-centered, with an asymmetrical client-server connection with all traffic routed through the access point, while Bluetooth is usually symmetrical, between two Bluetooth devices. Bluetooth serves well in simple applications where two devices need to connect with minimal configuration like a button press, as in headsets and remote controls, while Wi-Fi serves better in applications where some degree of client configuration is possible and high speeds are required, especially for network access through an access node. However, Bluetooth access points do exist and ad-hoc connections are possible with Wi-Fi though not as simply as with Bluetooth. One problem with using multiple access technologies at the same time is the battery drain caused by the continuous signaling with other devices and listening for signals from other devices. One solution to conserve batter power is to put the device into sleep mode.

Sleep mode is a process used in a radio receiver where electronic circuits (such as a receiver) are temporarily deactivated or put into a low power consumption mode (such as back lighting off) to save battery energy. Bluetooth sleep modes are used to reduce the power consumption (extend the battery life) and to free the Piconet (Bluetooth network) of device activity so other devices may participate in the Piconet. Bluetooth sleep modes include short one-time hold periods, periodic sniff periods (sniff mode), and long time park periods.

Sniff Mode/Sniffing—is a process of listening for specific types of commands that occur periodically. Sniffing is used for devices that must continuously be in contact with the master. The Bluetooth sniff mode is used to reduce the power consumption of the device as the receiver can be put into standby between sniff cycles. When a device's Bluetooth connection is idle, the connection is said to be in sniff mode. In sniff mode, the device connectivity system goes to sleep and periodically wakes up at sniff anchor points (the sniff interval is typically every ˜500 ms) to listen for signals. The device connectivity system wakes up after each sniff interval to listen for signals but to wake up the connectivity systems consumes current for the duration the device listens.

Similarly, when the device has a WLAN connection established with an access point and is not currently exchanging signals with the access point, the device connectivity system periodically wakes up at beacon points (the beacon interval is typically every ˜100 ms) to listen for beacon signals from the access point. The device connectivity system wakes up after each beacon interval to listen for beacon signals but to wake up the connectivity systems consumes current for the duration the device listens. Currently both wakeup cycles happen in a disjointed fashion; this makes the connectivity system wake up more instances and leads to higher average current consumption.

Accordingly, there is a need for systems, apparatus, and methods that improve upon the conventional uncoordinated wakeup cycles including the improved methods, system, and apparatus provided hereby.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples of the systems, apparatus, and methods disclosed herein in a simplified form to precede the detailed description presented below.

In one aspect, an apparatus for synchronizing time intervals is disclosed. The apparatus may include, for example, a first transceiver configured to wirelessly communicate with a first remote device and a second remote device; a communication controller configured to establish a first wireless connection with the first remote device and establish a second wireless connection with the second remote device; and the communication controller configured to set a first time interval to periodically listen for a first signal from the first remote device over the first wireless connection and set a second time interval to periodically listen for a second signal from the second remote device over the second wireless connection such that the second time interval is an integer multiple of the first time interval.

In another aspect, a method for synchronizing time intervals is disclosed. The method may include, for example, establishing a first wireless connection with a first remote device; setting a first time interval to listen for a first signal from the first remote device; establishing a second wireless connection with a second remote device; and setting a second time interval to listen for a second signal from the second remote device such that the second time interval is an integer multiple of the first time interval.

In still another aspect, another method for synchronizing time intervals is disclosed. The method may include, for example, establishing a first wireless connection with a first remote device; setting a first time interval to listen for a first signal from the first remote device; establishing a second wireless connection with a second remote device; setting a second time interval to listen for a second signal from the second remote device; and adjusting the first time interval such that the first time interval is an integer multiple of the second time interval.

Other features and advantages associated with the apparatus and methods disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communication system including an Access Point (AP) in communication with an Access Terminal (AT).

FIG. 2 illustrates an example wireless communication system including an AP in communication with a first AT that is in communication with a second AT.

FIG. 3 is a flow diagram illustrating an example method of synchronizing wakeup intervals.

FIG. 4 is another flow diagram illustrating an example method of synchronizing wakeup intervals.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and drawings.

### DETAILED DESCRIPTION

The exemplary methods, apparatus, and systems disclosed herein advantageously address the industry needs, as well as other previously unidentified needs, and mitigate shortcomings of the conventional methods, apparatus, and systems. For example, a first access terminal (e.g. a mobile device) that has both Bluetooth and Wi-Fi capabilities may include a communication controller that when the first access terminal detects that WLAN connectivity is turned ON, the communication controller adjusts the sniff anchor point for Bluetooth connectivity such that the sniff anchor points are aligned with the WLAN beacon intervals. In one example scenario, the first access terminal has the WLAN connectivity turned ON and connected to an access point before a Bluetooth connection to a second access terminal is established. The first access terminal knows of the WLAN status and knows of the beacon intervals (time to wake up to check for a beacon signal). The communication controller may set the Bluetooth sniff interval and sniff anchor points such that they are a multiple of the beacon interval. In another example scenario, the first access terminal has the WLAN connectivity turned ON and connected to an access point after a Bluetooth connection with a second access terminal is established. Once the WLAN connectivity is turned ON and associated with an access point, the communication controller may send a Link Management Protocol (LMP) command to the second access terminal to adjust the sniff anchor points such that the next anchor point happens at the WLAN beacon interval. The LMP controls and negotiates all aspects of the operation of the Bluetooth connection between the first access terminal and the second access terminal. This includes the set-up and control of logical transports and logical connections, and for control of physical connections.

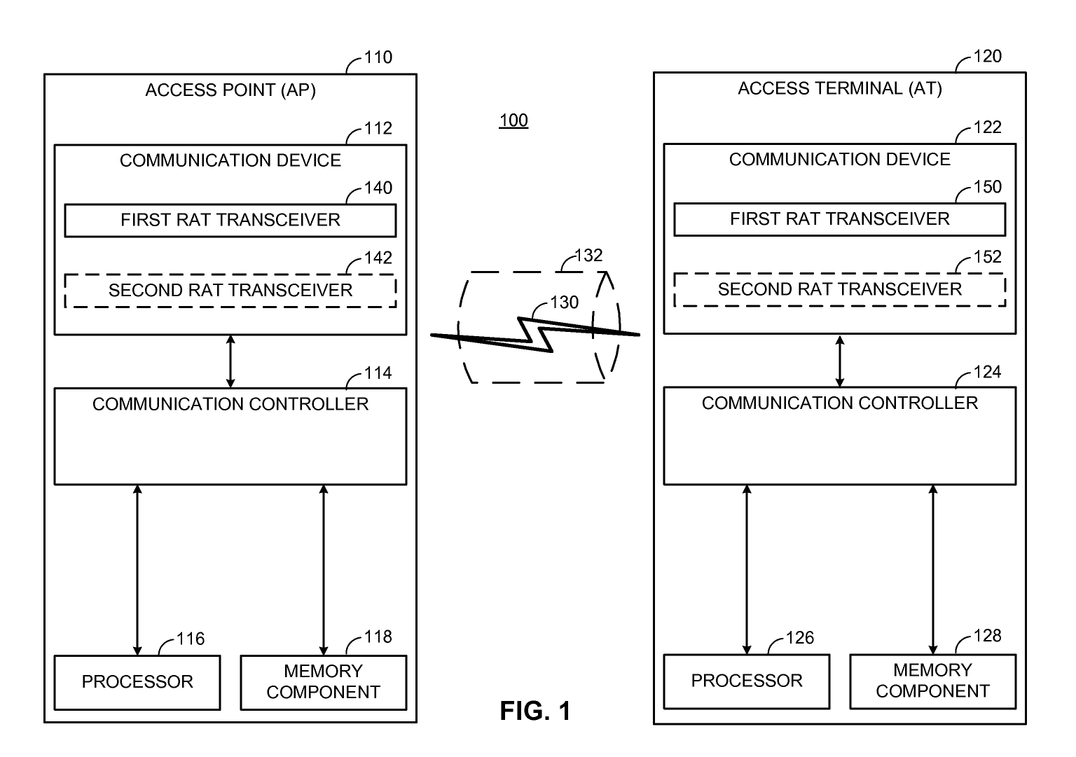

FIG. 1 illustrates an example wireless communication system 100 including an Access Point (AP) 110 in communication with an Access Terminal (AT) 120. Unless otherwise noted, the terms “access terminal” and “access point” are not intended to be specific or limited to any particular Radio Access Technology (RAT). In general, access terminals may be any wireless communication device allowing a user to communicate over a communications network (e.g., a mobile phone, router, personal computer, server, entertainment device, Internet of Things (IOT)/Internet of Everything (IOE) capable device, in-vehicle communication device, etc.), and may be alternatively referred to in different RAT environments as a User Device (UD), a Mobile Station (MS), a Subscriber Station (STA), a User Equipment (UE), etc. Similarly, an access point may operate according to one or several RATs in communicating with access terminals depending on the network in which the access point is deployed, and may be alternatively referred to as a Base Station (BS), a Network Node, a NodeB, an evolved NodeB (eNB), etc.

In the example of FIG. 1, the access point 110 and the access terminal 120 each generally include a wireless communication device (represented by the communication devices 112 and 122) for communicating with other network nodes via at least one designated RAT. The communication devices 112 and 122 may be variously configured for transmitting and encoding signals (e.g., messages, indications, information, and so on), and, conversely, for receiving and decoding signals (e.g., messages, indications, information, pilots, and so on) in accordance with the designated RAT (e.g. Wi-Fi 802.11 or Bluetooth). The access point 110 and the access terminal 120 may also each generally include a communication controller (represented by the communication controllers 114 and 124) for controlling operation of their respective communication devices 112 and 122 (e.g., directing, modifying, enabling, disabling, etc.). The communication controllers 114 and 124 may operate at the direction of, or otherwise in conjunction with, respective host system functionality (illustrated as the processor 116 and 126 and the memory components 118 and 128). In some designs, the communication controllers 114 and 124 may be partly or wholly subsumed by the respective host system functionality.

Turning to the illustrated wireless communication system in more detail, the access terminal 120 may transmit and receive messages via a first wireless connection 130 with the access point 110, the message including information related to various types of communication (e.g., voice, data, multimedia services, associated control signaling, etc.). The first wireless connection 130 may operate over a communication medium of interest, shown by way of example in FIG. 1 as the medium 132, which may be shared with other communications as well as other RATs. A medium of this type may be composed of one or more frequencies, time, and/or space communication resources (e.g., encompassing one or more channels across one or more carriers) associated with communication between one or more transmitter/receiver pairs, such as the access point 110 and the access terminal 120 for the medium 132.

As a particular example, the medium 132 may correspond to at least a portion of an unlicensed frequency band shared with other RATs. In general, the access point 110 and the access terminal 120 may operate via the first wireless connection 130 according to one or more RATs depending on the network in which they are deployed. These networks may include, for example, different variants of unlicensed frequency bands such as the Unlicensed National Information Infrastructure (U-NII) band used by Wireless Local Area Network (WLAN) technologies, most notably IEEE 802.11x WLAN technologies generally referred to as “Wi-Fi” and Bluetooth technologies such as managed by the Bluetooth Special Interest Group (SIG) and generally referred to as “Bluetooth.”

In the example of FIG. 1, the communication device 112 of the access point 110 includes a first RAT transceiver 140 configured to operate in accordance with one RAT (e.g. Wi-Fi) and, in some designs, an optional second RAT transceiver 142 configured to operate in accordance with another RAT (e.g. Bluetooth). As used herein, a “transceiver” may include a transmitter circuit, a receiver circuit, or a combination thereof, but need not provide both transmit and receive functionalities in all designs. For example, a low functionality receiver circuit may be employed in some designs to reduce costs when providing full communication is not necessary (e.g., a receiver chip or similar circuitry simply providing low-level sniffing). Further, as used herein, the term “co-located” (e.g., radios, access points, transceivers, etc.) may refer to one of various arrangements. For example, components that are in the same housing; components that are hosted by the same processor; components that are within a defined distance of one another; and/or components that are connected via an interface (e.g., an Ethernet switch) where the interface meets the latency requirements of any required inter-component communication (e.g., messaging).

The first RAT transceiver 140 and the second RAT transceiver 142 may provide different functionalities and may be used for different purposes. As an example, the first RAT transceiver 140 may operate in accordance with Wi-Fi technology to provide communication with the access terminal 120 on the first wireless connection 130, while the second RAT transceiver 142 (if equipped) may operate in accordance with Bluetooth technology to monitor Bluetooth signaling on the medium 132 that may interfere with, or be interfered with by, the Wi-Fi communications. The communication device 122 of the access terminal 120 may, in some designs, include similar first RAT transceiver and/or second RAT transceiver functionality, as shown in FIG. 1 by way of the first RAT transceiver 150 and the second RAT transceiver 152, although such dual-transceiver functionality may not be required.

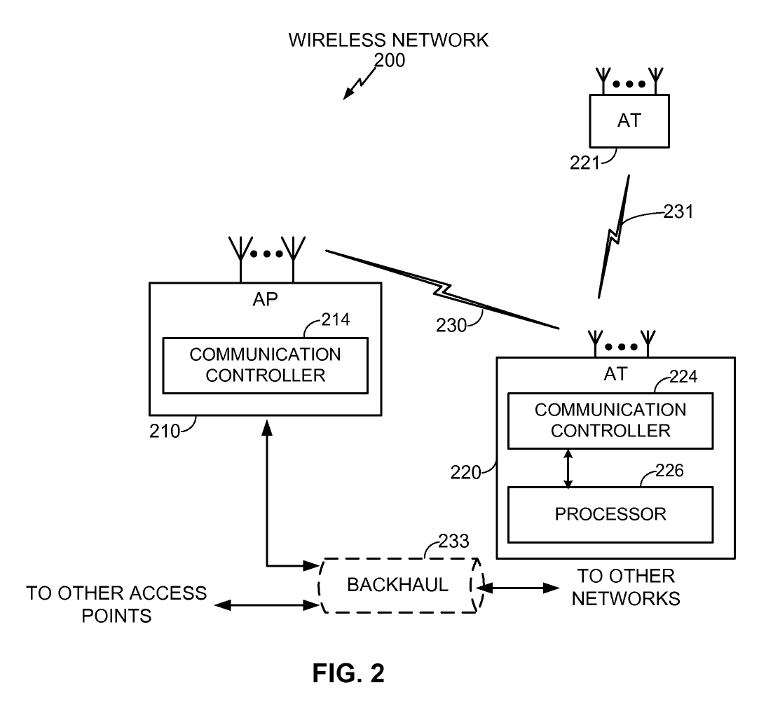

FIG. 2 illustrates an example wireless network 200 with a first AT 220 in communication with an AP 210 and a second AT 221. As shown, the wireless network 200 is formed from several wireless nodes, including an AP 210, a first AT 220, and a second AT 221. Each wireless node is generally capable of receiving and/or transmitting. The wireless network 200 may support any number of APs 210 distributed throughout a geographic region to provide coverage for additional ATs. For simplicity, one AP 210 is shown in FIG. 2, providing coordination and control among the first AT 220 and the second AT 221, as well as access to other APs or other networks (e.g., the Internet) via a backhaul connection 233.

The AP 210 is generally a fixed entity that provides backhaul services to the first AT 220 and the second AT 221 in its geographic region of coverage. However, the AP 210 may be mobile in some applications (e.g., a mobile device serving as a wireless hotspot for other devices). The first AT 220 and the second AT 221 may be fixed or mobile. Examples of the first AT 220 and the second AT 221 include a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, an automotive device in an automotive vehicle, a camera, a game console, a display device, or any other suitable wireless node. The wireless network 200 may be referred to as a wireless local area network (WLAN), and may employ a variety of widely used networking protocols to interconnect nearby devices. In general, these networking protocols may be referred to as “Wi-Fi,” including any member of the Institute of Electrical and Electronics Engineers (IEEE) 802.11 wireless protocol family.

As will be described in more detail below, these different entities may be variously configured in accordance with the teachings herein to provide or otherwise support synchronizing wakeup intervals for an AT between a Wi-Fi connection and a Bluetooth connection discussed briefly above.

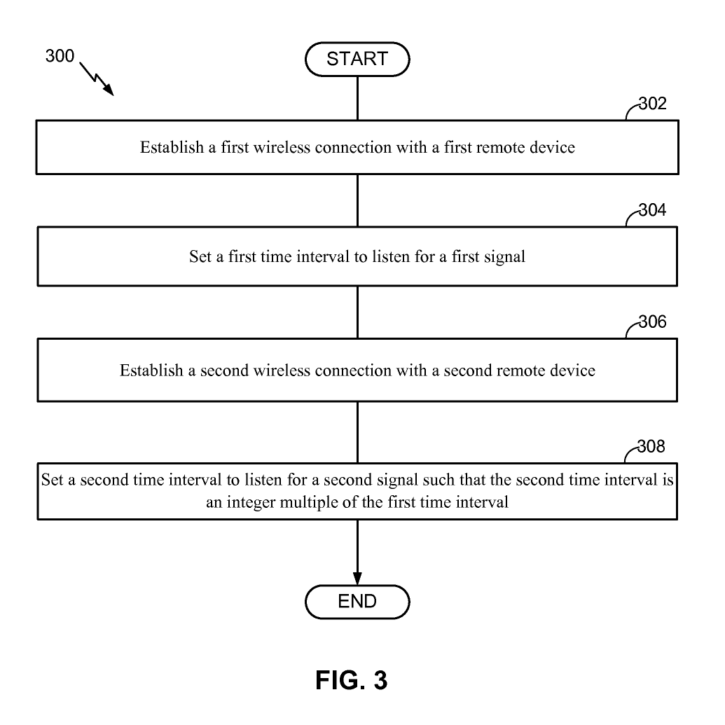

Returning to FIG. 2, as will be discussed in more detail below with reference to FIGS. 3-5, the first AT 220 may include a communication controller 224 that may control operation of a first wireless connection 230 with the AP 210 and a second wireless connection 231 with the second AT 221 in conjunction with a processor 226. The first wireless connection 230 may be a Wi-Fi connection and the second wireless connection 231 may be a Bluetooth connection.

To establish the first wireless connection 230, the communication controller 224 may wake up the processor 226 to begin the process. When the processor 226 receives a command from the communication controller 224 to establish the first wireless connection 230 with the AP 210, the processor 226 may take a first time interval (e.g. 4.35 ms) to wake up and resume operations that consume a significant amount of current (e.g. 13 mA). Once the first time interval has passed, the processor 226 and the communication controller 224 may take a second time interval (e.g. 1.41 ms) to handle the connection set up (or a beacon request). Then, the first AT 220 may begin exchanging information with the AP 210 over the first wireless connection 230. Once the active exchange of information pauses or ends, the first AT 220 may enter a beacon mode with the communication controller 224 setting a beacon interval (e.g. every ˜100 ms) to listen for beacon signals from the AP 210, and the processor 226 may take a third time interval (e.g. 2.69 ms) to exit active operations that consume a significant amount of current (e.g. 10.8 mA). After each beacon interval, the communication controller 224 may send a command to the processor 226 to wake up and check for a beacon signal similar to the process used to establish the first wireless connection 230 as outlined above.

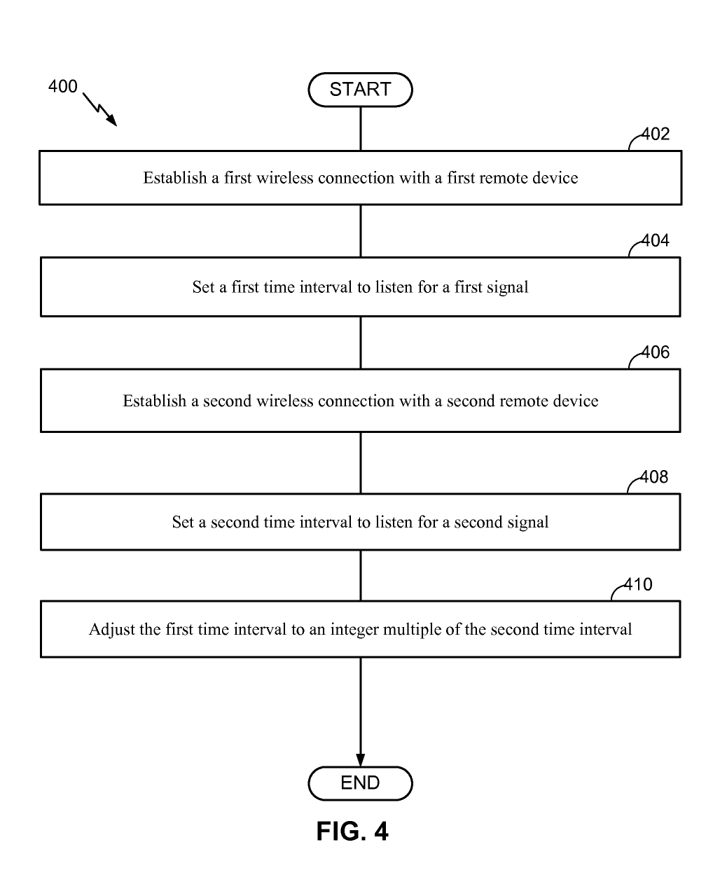

To establish the second wireless connection 231, the communication controller 224 may wake up the processor 226 to begin the process. When the processor 226 receives a command from the communication controller 224 to establish the second wireless connection 230 with the second AT 221, the processor 226 may take a first time interval (e.g. 4.8 ms) to wake up and resume operations that consume a significant amount of current (e.g. 20 mA). Once the first time interval has passed, the processor 226 and the communication controller 224 may take a second time interval (e.g. 7.65 ms) to handle the connection set up (or a sniff request). Then, the first AT 220 may begin exchanging information with the second AT 221 over the second wireless connection 231. Once the active exchange of information pauses or ends, the first AT 220 may enter a sniff mode with the communication controller 224 setting a sniff interval (e.g. every ˜500 ms) to listen at a sniff anchor point for sniff signals from the AP 210, and the processor 226 may take a third time interval (e.g. 3.17 ms) to exit active operations that consume a significant amount of current (e.g. 14 mA). After each sniff interval (at each sniff anchor point), the communication controller 224 may send a command to the processor 226 to wake up and check for a sniff signal similar to the process used to establish the second wireless connection 231 as outlined above. As will be discussed in further detail with reference to FIGS. 3 and 4, the communication controller 224 may adjust the sniff interval such that the sniff anchor point coincides with the beacon interval (e.g. an integer multiple of the beacon interval). This will allow the AT to conserve power and save time by performing a single processor wakeup process for each anchor point and a coinciding beacon interval.

FIG. 3 is a flow diagram illustrating an example method 300 for synchronizing wakeup intervals in accordance with the techniques described above. The method 300 may be performed, for example, by an AT (e.g., the first AT 220 illustrated in FIG. 2).

As shown in block 302, the AT (e.g. first AT 220) may establish a first wireless connection (e.g. first wireless connection 230 such as a Wi-Fi connection) with a first remote device (e.g. AP 210). In block 304, the AT may set a first time interval (e.g. a beacon interval) to wake up a processor (e.g. processor 226) to listen for a first signal (e.g. a beacon signal). In block 306, the AT may establish a second wireless connection (e.g. second wireless connection 231 such as a Bluetooth connection) with a second remote device (e.g. second AT 221). In block 308, the AT may set a second time interval (e.g. a sniff interval) to wake up the processor to listen for a second signal (e.g. a sniff signal) such that the second time interval is an integer multiple of the first time interval that coincides with a time the processor wakes up to listen for the first signal. The above activity may be performed, for example, by a communication controller (e.g. communication controller 224) and the processor in conjunction with a first transceiver (e.g. first RAT transceiver 150) by itself or in conjunction with the first transceiver and a second transceiver (e.g. second RAT transceiver 152) or the like. For example, the communication controller may initiate a sniff command in-line with an immediate beacon. Once the second wireless connection goes into sniff mode, the communication controller calculates the next sniff anchor point to determine how much time delta is between sniff anchor points and beacon intervals. At the next anchor point, a communication controller in the second remote device initiates a LMP command to adjust the second time interval for the next anchor point.

FIG. 4 is a flow diagram illustrating another example method 400 for synchronizing wakeup intervals in accordance with the techniques described above. The method 400 may be performed, for example, by an AT (e.g., the first AT 220 illustrated in FIG. 2).

As shown in block 402, the AT (e.g. first AT 220) may establish a first wireless connection (e.g. second wireless connection 231 such as a Bluetooth connection) with a first remote device (e.g. second AT 221). In block 404, the AT may set a first time interval (e.g. a sniff interval) to wake up a processor (e.g. processor 226) to listen for a first signal (e.g. a sniff signal). In block 406, the AT may establish a second wireless connection (e.g. first wireless connection 230 such as a Wi-Fi connection) with a second remote device (e.g. AP 210). In block 408, the AT may set a second time interval (e.g. a beacon interval) to wake up the processor to listen for a second signal (e.g. a beacon signal). In block 410, the AT may adjust the first time interval to an integer multiple of the second time interval that coincides with a time that the processor wakes up to listen for the second signal. The above activity may be performed, for example, by a communication controller (e.g. communication controller 224) and the processor in conjunction with a first transceiver (e.g. first RAT transceiver 150) by itself or in conjunction with the first transceiver and a second transceiver (e.g. second RAT transceiver 152) or the like. For example, once the second wireless connection is established, the communication controller may send a LMP command to the first remote device to adjust the first time interval such that the next anchor point coincides with a time that the processor wakes up to listen for the second signal.

The activity described in FIGS. 3 and 4 may be implemented in various ways consistent with the teachings herein. In some designs, the activity may be implemented as one or more electrical components. In some designs, some of the activity may be implemented as a processing system including one or more processor components. In some designs, some of the activity may be implemented using, for example, at least a portion of one or more integrated circuits (e.g., an ASIC). As discussed herein, an integrated circuit may include a processor, software, other related components, or some combination thereof. Thus, the activity may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of more than one activity.

In addition, the components and activity described herein may be implemented using any suitable means. Such means also may be implemented, at least in part, using corresponding structure as taught herein. For example, the components and activities described above in conjunction with FIGS. 1-4 also may correspond to similarly designated “means for” functionality. Thus, in some aspects one or more of such means may be implemented using one or more of processor components, communication controllers, transceivers, or other suitable structures as taught herein.

Further, many aspects are described in terms of sequences of actions to be performed by, for example, elements of a communication device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

It should be understood that any reference to an element herein using a designation such as “first,” “second,” and so forth, does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in Random-Access Memory (RAM), flash memory, Read-only Memory (ROM), Erasable Programmable Read-only Memory (EPROM), Electrically Erasable Programmable Read-only Memory (EEPROM), registers, hard disk, a removable disk, a CD-ROM, or any other form of storage medium known in the art, transitory or non-transitory. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a transitory or non-transitory computer-readable medium embodying a method for synchronizing wakeup intervals between various RATs operating in the same access terminal.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. An apparatus comprising:
a first transceiver configured to wirelessly communicate with a first remote device and a second remote device;
a communication controller configured to establish a first wireless connection with the first remote device and establish a second wireless connection with the second remote device; and
the communication controller configured to set a first time interval to periodically listen for a first signal from the first remote device over the first wireless connection and set a second time interval to periodically listen for a second signal from the second remote device over the second wireless connection such that the second time interval is an integer multiple of the first time interval.

2. The apparatus of claim 1, wherein the first wireless connection is a Wi-Fi connection, the second wireless connection is a Bluetooth connection, the first time interval is a beacon interval, and the second time interval is a sniff interval.

3. The apparatus of claim 1, further comprising a processor configured to process the first signal and the second signal; and wherein the communication controller is configured to wake up the processor at an end of the first time interval to receive the first signal for processing and to wake up the processor at an end of the second time interval to receive the second signal for processing.

4. The apparatus of claim 1, further comprising a second transceiver configured to wirelessly communicate with the second remote device; wherein the communication controller establishes the first wireless connection using the first transceiver and establishes the second wireless connection using the second transceiver.

5. The apparatus of claim 1, wherein the communication controller is configured to adjust the second time interval after setting the second time interval.

6. The apparatus of claim 5, wherein the communication controller is configured to adjust the second time interval by sending a link management protocol (LMP) command to the second remote device.

7. The apparatus of claim 1, wherein an end of the second time interval coincides with an end of the first time interval.

8. The apparatus of claim 1, wherein the apparatus is incorporated into a device selected from a group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and an automotive device in an automotive vehicle, and further includes the device.

9. A method for synchronizing time intervals, comprising:
establishing a first wireless connection with a first remote device;
setting a first time interval to listen for a first signal from the first remote device;
establishing a second wireless connection with a second remote device; and
setting a second time interval to listen for a second signal from the second remote device such that the second time interval is an integer multiple of the first time interval.

10. The method of claim 9, wherein the first wireless connection is a Wi-Fi connection, the second wireless connection is a Bluetooth connection, the first time interval is a beacon interval, and the second time interval is a sniff interval.

11. The method of claim 9, wherein a communication controller wakes up a processor at an end of the first time interval to listen for the first signal and wakes up the processor at an end of the second time interval to listen for the second signal.

12. The method of claim 11, further comprising adjusting the second time interval after setting the second time interval such that the end of the second time interval coincides with the end of the first time interval.

13. The method of claim 12, wherein the second time interval is adjusted by sending a link management protocol (LMP) command to the second remote device.

14. The method of claim 9, wherein the method is performed by a device selected from a group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and an automotive device in an automotive vehicle, and further includes the device.

15. A method for synchronizing time intervals, comprising:
establishing a first wireless connection with a first remote device;
setting a first time interval to listen for a first signal from the first remote device;
establishing a second wireless connection with a second remote device;
setting a second time interval to listen for a second signal from the second remote device; and
adjusting the first time interval such that the first time interval is an integer multiple of the second time interval.

16. The method of claim 15, wherein the first wireless connection is a Bluetooth connection, the second wireless connection is a Wi-Fi connection, the first time interval is a sniff interval, and the second time interval is a beacon interval.

17. The method of claim 15, wherein a communication controller wakes up a processor at an end of the first time interval to listen for the first signal and wakes up the processor at an end of the second time interval to listen for the second signal.

18. The method of claim 17, wherein the end of the first time interval is adjusted to coincide with the end of the second time interval.

19. The method of claim 18, wherein the first time interval is adjusted by sending a link management protocol (LMP) command to the first remote device.

20. The method of claim 15, wherein the method is performed by a device selected from a group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and an automotive device in an automotive vehicle, and further includes the device.
